(19) United States
(12) Patent Application Publication
(10) Pub. No.: US 2003/0054890 A1
(43) Pub. Date: Mar. 20, 2003

(54) Dual mass flywheel

(76) Inventor: Soon-Jae Hong, Kyungki-do (KR)

Correspondence Address: Pennie & Edmonds, LLP, 3300 Hillview Avenue, Palo Alto, CA, 94304, US

(21) Appl. No.: 10/246,314

(22) Filed: Sep. 17, 2002

(30) Foreign Application Priority Data
Sep. 18, 2001 (KR) 2001-0057500

(51) Int. Cl. F16D 3/66

(52) U.S. Cl. 464/66

(57) ABSTRACT

An assembly structure and manufacturing process of a dual mass flywheel are simplified and its production cost is reduced, by disposing a vibration-reducing unit between first and second mass members. The vibration-reducing unit includes an elastic member producing a tangential elastic force to both the first mass member and a drive plate and a pin joint disposed at each end of the elastic member. The pin joint is abutted by at least one of a guide bracket of the first mass member and an engaging portion of the second mass member.

### FIELD OF THE INVENTION

The present invention relates to a dual mass flywheel, and more particularly, to a dual mass flywheel for reducing noise and torque shock during torque transmission.

### BACKGROUND OF THE INVENTION

A dual mass flywheel modulates torque input from an engine and transmits the modulated torque to a transmission via a clutch system. A conventional dual mass flywheel for a vehicle includes a first mass member engaged with a crankshaft of an engine, a second mass member facing the first mass member and connected to a clutch disk, and one or more springs disposed between the first and second mass members.

In such a conventional dual mass flywheel having separate first and second mass members, the second mass member acts as a dynamic damper to dampen torque vibration, and a clutch system is attached to the second mass member, such that torque transmission between the second mass member and a transmission is controlled.

One example of a conventional dual mass flywheel, as shown in FIG. 1A, has an arc-shaped coil spring 130 between a first mass member 110 and a second mass member (not shown). When the second mass member rotates relative to the first mass member, a drive plate fixed to the second mass member compresses the arc-shaped coil spring 110.

Another example of a conventional dual mass flywheel, as shown in FIG. 1B, uses extension springs 130 such that relative motion between first and second mass members is recovered by a restoring force due to an extended length of the springs 130.

In yet another example of a conventional dual mass flywheel, as shown in FIG. 1C, a multiplicity of springs 130 are tangentially disposed, each spring producing an elastic force between first and second mass members.

According to such conventional dual mass flywheels of the prior art, a lubricant such as grease and a seal are needed, which increases the number of constituent parts, and accordingly the manufacturing complexity and production cost are increased.

### SUMMARY OF THE INVENTION

The present invention provides a dual mass flywheel with a simplified structure, a simplified manufacturing process, and a reduced production cost. According to a preferred embodiment of the present invention, a first mass member is provided with a plurality of guide brackets. A drive plate is rotatably engaged with the first mass member and provided with a plurality of engaging portions. E ach of the engaging portions is slidably engaged with each of the guide brackets. A vibration reducing unit is also provided and a second mass member is fixed to the drive plate.

The vibration reducing unit preferably includes an elastic member for producing biasing torque between the first mass member and the drive plate and a pin joint disposed at each end of the elastic member. The pin joint is abutted by at least one of the guide bracket and the engaging portion.

In a further preferred embodiment, the drive plate includes a base plate of a polygonal shape, with the engaging portions protruding outward from edges of the base, and a circular circumference also connected to the engaging portions. The circular circumference is slidably engaged with the first mass member when the drive plate rotates.

In a further preferred embodiment, the first mass member is provided with four guide brackets, and the base plate is of a square shape.

The pin joint preferably includes an adapter connected to the elastic member, a pin joint head abutted by at least one of the guide bracket and the engaging portion according to a rotating motion of the base plate, and a pin rotatably connecting the adapter and the pin joint head.

In a further preferred embodiment, the elastic member is a coil spring, and the adapter comprises a radial protrusion for supporting the coil spring, and an axial protrusion for being inserted into the coil spring.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIGS. 1A, 1B, and 1C respectively illustrate conventional dual mass flywheels;

FIG. 2 is an exploded perspective view of a dual mass flywheel according to the present invention;

FIG. 3 is a front view of an assembled dual mass flywheel according to a preferred embodiment of the present invention; and

FIG. 4 is a cross-sectional view of a pin joint according to a preferred embodiment of the present invention, the cross-section being along an axis of a pin thereof.

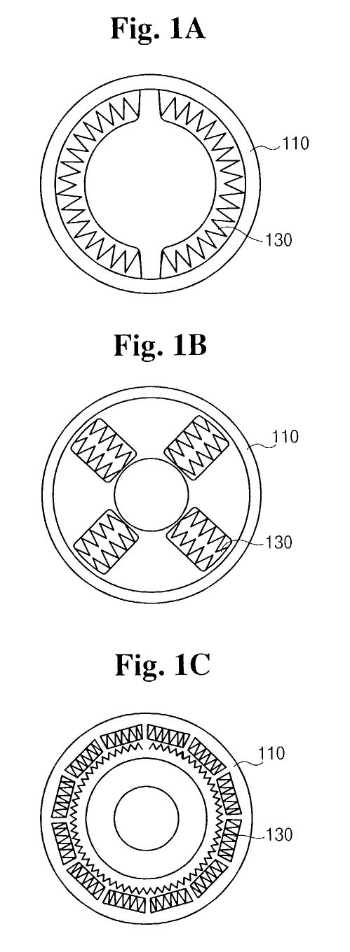

### DETAILED DESCRIPTION OF THE PREFERRED EMBODIMENTS

A preferred embodiment of the present invention will hereinafter be described in detail with reference to the accompanying drawings.

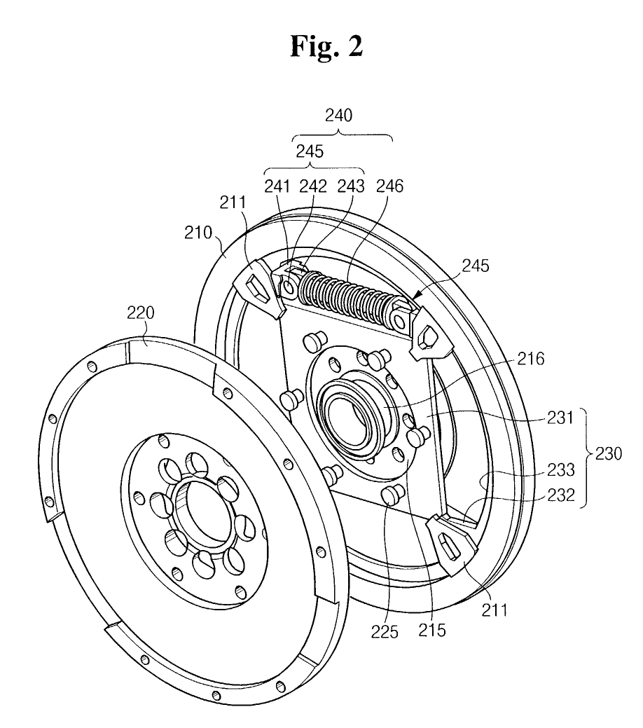

As shown in FIG. 2, a dual mass flywheel according to a preferred embodiment of the present invention includes a first mass member 210 provided with a plurality of guide brackets 211. A drive plate 230 is rotatably engaged with the first mass member 210 and is provided with a plurality of engaging portions 232, each of the engaging portions 232 being slidably engaged with each of the guide brackets 211. A second mass member 220 is fixed to the drive plate 230.

A vibration reducing unit 240 is further included in the preferred embodiment. The vibration reducing unit 240 includes: an elastic member 246 for producing biasing torque between the first mass member 210 and the drive plate 230, and a pin joint 245 disposed at each end of the elastic member 246. The pin joint 245 is abutted by at least one of the guide bracket 211 and the engaging portion 232.

The first mass member 210 is fixed to a crankshaft of an engine, when the engine is fully assembled. A hub plate 215 is disposed at the center of the first mass member 210, the hub plate 215 having a plurality of holes through which the first mass member 210 is bolted to the crankshaft of the engine.

A bearing 216 is installed at the hub plate 215 such that the second mass member can be assembled to the first mass member 210 with the bearing 216 disposed therebetween, when the second member 220 is fixed to the drive plate 230 by a plurality of rivets 225.

The drive plate 230 is formed including a base plate 231 of a polygonal shape, the engaging portion 232 protruding outward from an edge of the base plate 231, and a circular circumference 233 also connected to the engaging portion 232. The circular circumference 233 is slidably engaged with the first mass member 210 when the drive plate 230 rotates.

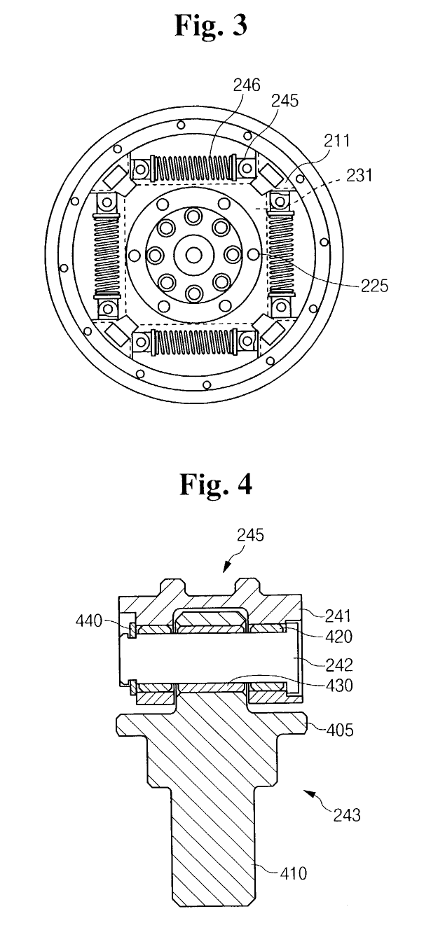

As shown in FIG. 2, the first mass member 210 is provided with four guide brackets 211, and the base plate 231 is of a square shape. The elastic member 246 is preferably a coil spring also as shown. In FIG. 2, only one elastic member is shown for simplicity in order to enhance understanding of the preferred embodiment. However, such a vibration reducing unit 240 is disposed between pairs of adjacent guide brackets 211, as shown in FIG. 3.

As also shown in FIG. 2 and in more detail in FIG. 4, the pin joint 245 includes an adapter 243 connected to the elastic member 246. A pin joint head 241 is abutted by at least one of the guide bracket 211 and the engaging portion 232 according to rotating motion of the base plate 230. A pin 242 rotatably connects the adapter 243 and the pin joint head 241.

As shown in FIG. 4, a radial protrusion 405 for supporting the coil spring 246 and an axial protrusion 410 inserted into the coil spring 246 are formed at the adapter 243. The pin 242 penetrates the pin joint head 241 interposing a bushing 420 therebetween, and the adapter 243 interposing a bushing 430 therebetween. At an end of the pin 242, a snap ring 440 is installed to prevent separation of the pin 242.

Operation of the preferred embodiment of the present invention is hereinafter described in detail.

When relative motion between the drive plate 230 and the first mass member 210 occurs, for example, when the drive plate 230 rotates relative to the first mass member 210, one of the pin joints 245 that are located at both ends of each elastic member 246 is pushed by an engaging portion 232 of the drive plate 230, and another of the pin joints 245 is supported by the guide bracket 211. Accordingly, the elastic member 246 is compressed and exerts elastic force to recover the original position of the drive plate 230 relative to the first mass member 210.

When the elastic member 246 is compressed, the relative direction in which the elastic member is aligned varies. This is enabled by the pin joint 245 because the pin joint head 241 and the adapter 243 are rotatably interconnected by the pin 242. In this case, the pin joint head 241 can support the elastic force with the pin joint head 241 and the adapter 243 not being coaxially aligned. The pin joint 245 has been found to be able to support sufficient elastic force within the offset angle range of ±20°.

When torque of an engine crankshaft is transmitted to the first mass member 210, a torque shock is absorbed at the vibration reducing unit 240 including the pin joint 230 and the elastic member 246 before the torque is subsequently transmitted to the drive plate 230 and accordingly to the second mass member 220. Accordingly, the torque received at the second mass member 220 has reduced torque fluctuation relative to the torque input to the first mass member 210. The torque with reduced fluctuation is transmitted to a transmission (not shown) via a clutch disk (not shown).

According to the preferred embodiment, the separate first and second mass members 210 and 220 reduce a booming noise of a vehicle and a rattle noise of a transmission. Moreover, torque shock is reduced when a vehicle is under hard acceleration and deceleration, and drivability of a vehicle is enhanced.

Compared to a conventional dual mass flywheel of the prior art using grease and a seal, the preferred embodiment of this invention is a dry-type, where the necessity for such grease and seal is substantially reduced, and it has a simplified structure.

Furthermore, the simplified structure of the dual mass flywheel of the preferred embodiment of the present invention enables the manufacturing process to be simplified, and accordingly the production cost and weight are reduced.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

What is claimed is:

1. A dual mass flywheel comprising:
a first mass member provided with a plurality of guide brackets;
a drive plate rotatably engaged with the first mass member and provided with a plurality of engaging portions, each of the engaging portions being slidably engaged with each of the guide brackets;
a vibration reducing unit comprising:
an elastic member producing biasing torque between the first mass member and the drive plate; and
a pin joint disposed at each end of the elastic member, the pin joint being abutted by at least one of the guide bracket and the engaging portion; and
a second mass member fixed to the drive plate.

2. The dual mass flywheel of claim 1, wherein the drive plate comprises:
a base plate of a polygonal shape, wherein the engaging portions protrude outward from edges of the base plate; and
a circular circumference, also connected to the engaging portions, the circular circumference being slidably engaged with the first mass member when the drive plate rotates.

3. The dual mass flywheel of claim 2, wherein the first mass member is provided with four guide brackets, and the base plate is of a square shape.

4. The dual mass flywheel of claim 1, wherein the pin joint comprises:
an adapter connected to the elastic member;
a pin joint head abutted by at least one of the guide bracket and the engaging portion according to a rotating motion of the base plate; and
a pin rotatably connecting the adapter and the pin joint head.

5. The dual mass flywheel of claim 4, wherein the elastic member is a coil spring, and the adapter comprises a radial protrusion for supporting the coil spring and an axial protrusion for being inserted into the coil spring.
